(19) United States
(12) Patent Application Publication
(10) Pub. No.: US 2016/0093870 A1
(43) Pub. Date: Mar. 31, 2016

(54) BATTERY MODULE WATER MANAGEMENT FEATURES

(71) Applicant: Johnson Controls Technology Company, Holland, MI (US)

(72) Inventors: Richard M. DeKeuster, Racine, WI (US); Robert J. Mack, Milwaukee, WI (US); Kem M. Obasih, Brookfield, WI (US); Ken Nakayama, Franklin, WI (US)

(21) Appl. No.: 14/503,016

(22) Filed: Sep. 30, 2014

(51) Int. Cl. H01M 2/36; H01M 2/10; H01M 10/0525

(52) U.S. Cl. CPC H01M 2/364; H01M 10/0525; H01M 2/1077; H01M 2220/20

(57) ABSTRACT

The present disclosure includes a battery module having a housing configured to receive one or more electrochemical cells. The housing includes a bottom internal surface and a recessed portion disposed in the bottom internal surface and proximate to a low point on the bottom internal surface, wherein the recessed portion defines an airspace configured to retain fluid within the housing away from the one or more electrochemical cells.

### BACKGROUND

The present disclosure relates generally to the field of batteries and battery modules. More specifically, the present disclosure relates to water management features for Lithium-ion (Li-ion) battery modules.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

A vehicle that uses one or more battery systems for providing all or a portion of the motive power for the vehicle can be referred to as an xEV, where the term “xEV” is defined herein to include all of the following vehicles, or any variations or combinations thereof, that use electric power for all or a portion of their vehicular motive force. For example, xEVs include electric vehicles (EVs) that utilize electric power for all motive force. As will be appreciated by those skilled in the art, hybrid electric vehicles (HEVs), also considered xEVs, combine an internal combustion engine propulsion system and a battery-powered electric propulsion system, such as 48 Volt (V) or 130V systems. The term HEV may include any variation of a hybrid electric vehicle. For example, full hybrid systems (FHEVs) may provide motive and other electrical power to the vehicle using one or more electric motors, using only an internal combustion engine, or using both. In contrast, mild hybrid systems (MHEVs) disable the internal combustion engine when the vehicle is idling and utilize a battery system to continue powering the air conditioning unit, radio, or other electronics, as well as to restart the engine when propulsion is desired. The mild hybrid system may also apply some level of power assist, during acceleration for example, to supplement the internal combustion engine. Mild hybrids are typically 96V to 130V and recover braking energy through a belt or crank integrated starter generator. Further, a micro-hybrid electric vehicle (mHEV) also uses a “Stop-Start” system similar to the mild hybrids, but the micro-hybrid systems of a mHEV may or may not supply power assist to the internal combustion engine and operates at a voltage below 60V. For the purposes of the present discussion, it should be noted that mHEVs typically do not technically use electric power provided directly to the crankshaft or transmission for any portion of the motive force of the vehicle, but an mHEV may still be considered as an xEV since it does use electric power to supplement a vehicle's power needs when the vehicle is idling with internal combustion engine disabled and recovers braking energy through an integrated starter generator. In addition, a plug-in electric vehicle (PEV) is any vehicle that can be charged from an external source of electricity, such as wall sockets, and the energy stored in the rechargeable battery packs drives or contributes to drive the wheels. PEVs are a subcategory of EVs that include all-electric or battery electric vehicles (BEVs), plug-in hybrid electric vehicles (PHEVs), and electric vehicle conversions of hybrid electric vehicles and conventional internal combustion engine vehicles.

xEVs as described above may provide a number of advantages as compared to more traditional gas-powered vehicles using only internal combustion engines and traditional electrical systems, which are typically 12V systems powered by a lead acid battery. For example, xEVs may produce fewer undesirable emission products and may exhibit greater fuel efficiency as compared to traditional internal combustion vehicles and, in some cases, such xEVs may eliminate the use of gasoline entirely, as is the case of certain types of EVs or PEVs.

As technology continues to evolve, there is a need to provide improved power sources, particularly battery modules, for such vehicles. For example, traditional battery modules are susceptible to condensation, water, or other fluids gathering inside a housing of the battery module, which may negatively affect components (e.g., electrical components) of the battery module and electrochemical cells thereof.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates to a battery module having a housing configured to receive one or more electrochemical cells. The housing includes a bottom internal surface and a recessed portion disposed in the bottom internal surface and proximate to a low point on the bottom internal surface, wherein the recessed portion defines an airspace configured to retain fluid within the housing away from the one or more electrochemical cells.

The present disclosure also relates to a housing configured to house a plurality of electrochemical cells. The housing includes a bottom side having a bottom internal surface. The housing also includes an opening extending through the bottom side and disposed at a low point on the bottom internal surface such that fluid is gravity fed from the bottom internal surface toward the opening. The opening is configured to drain the fluid through the bottom side of the housing.

The present disclosure further relates to a battery module having a housing configured to house a plurality of electrochemical cells. The housing includes a bottom internal surface on a bottom side of the housing. The housing also includes an opening extending through the bottom side from the bottom internal surface to a bottom external surface and disposed at a low point on the bottom internal surface, such that fluid is gravity fed from the bottom internal surface toward the opening. The opening is configured to selectively drain the fluid from an inside of the housing to an outside of the housing and the opening comprises a self-sealing port having a plunger seal or a pressure relief seal.

### DRAWINGS

Various aspects of this disclosure may be better understood upon reading the following detailed description and upon reference to the drawings in which:

FIG. 1 is a perspective view of a vehicle having a battery system configured in accordance with present embodiments to provide power for various components of the vehicle;

FIG. 2 is a cutaway schematic view of an embodiment of the vehicle and the battery system of FIG. 1;

FIG. 3 is a partially exploded perspective view of an embodiment of a battery module for use in the vehicle of FIG. 1;

FIG. 4 is a partially exploded perspective view of a portion of the battery module of FIG. 3, in accordance with an aspect of the present disclosure;

FIG. 5 is a perspective view of a portion of a housing of a battery module, in accordance with an aspect of the present disclosure;

FIG. 6 is a cross-sectional perspective view of a plunger drain through a base of a housing of a battery module, in accordance with an aspect of the present disclosure;

FIG. 7 is a cross-sectional side view of the plunger drain through the base of the housing of FIG. 6, in accordance with an aspect of the present disclosure;

FIG. 8 is a cross-sectional side view of a plunger drain through a base of a housing of a battery module, in accordance with an aspect of the present disclosure;

FIG. 9 is a cross-sectional perspective view of a pressure release drain through a base of a housing of a battery module, in accordance with an aspect of the present disclosure;

FIG. 10 is a cross-sectional side view of a pressure release drain through a base of a housing of a battery module, in accordance with an aspect of the present disclosure; and

FIG. 11 is a cross-sectional side view of a pressure release drain through a base of a housing of a battery module, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The battery systems described herein may be used to provide power to various types of electric vehicles (xEVs) and other high voltage energy storage/expending applications (e.g., electrical grid power storage systems). Such battery systems may include one or more battery modules, each battery module having a housing and a number of battery cells (e.g., Lithium-ion (Li-ion) electrochemical cells) arranged within the housing to provide particular voltages and/or currents useful to power, for example, one or more components of an xEV. As another example, battery modules in accordance with present embodiments may be incorporated with or provide power to stationary power systems (e.g., non-automotive systems).

Battery modules in accordance with the present disclosure may be susceptible to ingress of water or other fluids into the housing of the battery module. For example, the battery module may include thermal management features configured to route a coolant proximate to the housing of the battery module. The coolant may be liquid or vaporized water and may, for example, be capable of leaking (e.g., ingressing) into the housing. Furthermore, condensation may occur within a battery module due to temperature gradients and atmospheric conditions.

Accordingly, battery modules in accordance with the present disclosure include certain fluid management features (e.g., water management features) configured to gather fluid in a safe portion of the housing of the battery module. For example, a channel or recess (e.g., recessed portion) may be disposed on a bottom internal surface of the housing at or proximate to a low or lowest point on the bottom internal surface, such that fluid gathers within the channel or recess away from the electrochemical cells stored in the housing and away from other electrical components that may be disposed within, or extend into, an inside of the housing. Additionally or alternatively, the battery module may include certain fluid management features (e.g., water management features) configured to drain the fluid from the housing of the battery module. For example, a pinhole, a self-sealing port, a plunger seal, and/or a pressure relief seal may be disposed on the bottom internal surface of the battery module at or proximate to the low or lowest point on the bottom internal surface, such that fluid gathers proximate the pinhole, self-sealing port, or pressure relief seal and the pinhole, self-sealing port, or pressure relief seal drains the water (e.g., due at least in part to gravity) from the inside of the housing. The water management feature(s) are generally disposed proximate to the low or lowest point on the bottom internal surface of the housing to enable the fluid to be gravity fed toward and/or into the water management feature(s).

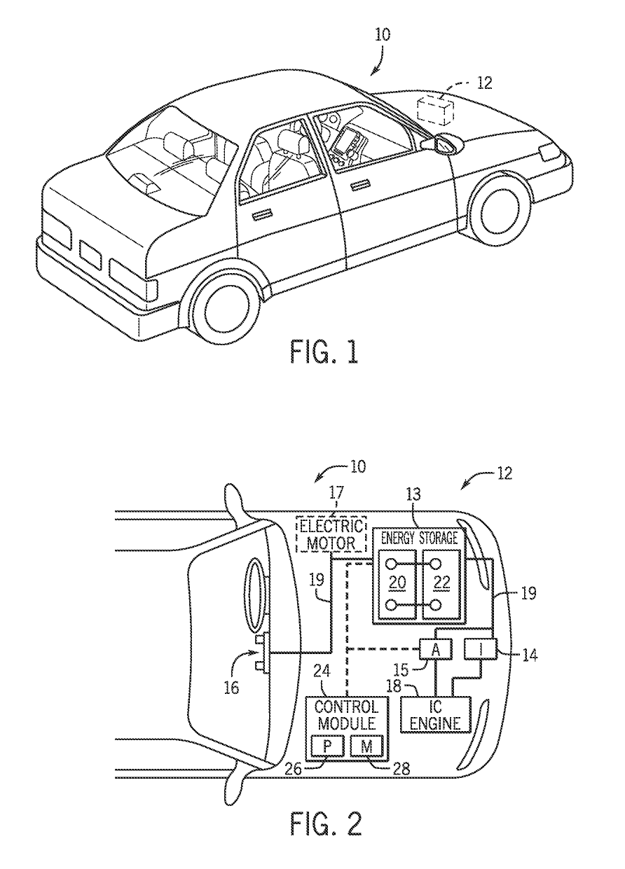

To help illustrate, FIG. 1 is a perspective view of an embodiment of a vehicle 10, which may utilize a regenerative braking system. Although the following discussion is presented in relation to vehicles with regenerative braking systems, the techniques described herein are adaptable to other vehicles that capture/store electrical energy with a battery, which may include electric-powered and gas-powered vehicles.

As discussed above, it would be desirable for a battery system 12 to be largely compatible with traditional vehicle designs. Accordingly, the battery system 12 may be placed in a location in the vehicle 10 that would have housed a traditional battery system. For example, as illustrated, the vehicle 10 may include the battery system 12 positioned similarly to a lead-acid battery of a typical combustion-engine vehicle (e.g., under the hood of the vehicle 10). Furthermore, as will be described in more detail below, the battery system 12 may be positioned to facilitate managing temperature of the battery system 12. For example, in some embodiments, positioning a battery system 12 under the hood of the vehicle 10 may enable an air duct to channel airflow over the battery system 12 and cool the battery system 12.

A more detailed view of the battery system 12 is described in FIG. 2. As depicted, the battery system 12 includes an energy storage component 13 coupled to an ignition system 14, an alternator 15, a vehicle console 16, and optionally to an electric motor 17. Generally, the energy storage component 13 may capture/store electrical energy generated in the vehicle 10 and output electrical energy to power electrical devices in the vehicle 10.

In other words, the battery system 12 may supply power to components of the vehicle's electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, or any combination thereof. Illustratively, in the depicted embodiment, the energy storage component 13 supplies power to the vehicle console 16 and the ignition system 14, which may be used to start (e.g., crank) the internal combustion engine 18.

Additionally, the energy storage component 13 may capture electrical energy generated by the alternator 15 and/or the electric motor 17. In some embodiments, the alternator 15 may generate electrical energy while the internal combustion engine 18 is running. More specifically, the alternator 15 may convert the mechanical energy produced by the rotation of the internal combustion engine 18 into electrical energy. Additionally or alternatively, when the vehicle 10 includes an electric motor 17, the electric motor 17 may generate electrical energy by converting mechanical energy produced by the movement of the vehicle 10 (e.g., rotation of the wheels) into electrical energy. Thus, in some embodiments, the energy storage component 13 may capture electrical energy generated by the alternator 15 and/or the electric motor 17 during regenerative braking. As such, the alternator 15 and/or the electric motor 17 are generally referred to herein as a regenerative braking system.

To facilitate capturing and supplying electric energy, the energy storage component 13 may be electrically coupled to the vehicle's electric system via a bus 19. For example, the bus 19 may enable the energy storage component 13 to receive electrical energy generated by the alternator 15 and/or the electric motor 17. Additionally, the bus 19 may enable the energy storage component 13 to output electrical energy to the ignition system 14 and/or the vehicle console 16. Accordingly, when a 12 volt battery system 12 is used, the bus 19 may carry electrical power typically between 8-18 volts.

Additionally, as depicted, the energy storage component 13 may include multiple battery modules. For example, in the depicted embodiment, the energy storage component 13 includes a lithium ion (e.g., a first) battery module 20 and a lead-acid (e.g., a second) battery module 22, which each includes one or more battery cells. In other embodiments, the energy storage component 13 may include any number of battery modules. Additionally, although the lithium ion battery module 20 and lead-acid battery module 22 are depicted adjacent to one another, they may be positioned in different areas around the vehicle. For example, the lead-acid battery module 22 may be positioned in or about the interior of the vehicle 10 while the lithium ion battery module 20 may be positioned under the hood of the vehicle 10.

In some embodiments, the energy storage component 13 may include multiple battery modules to utilize multiple different battery chemistries. For example, when the lithium ion battery module 20 is used, performance of the battery system 12 may be improved since the lithium ion battery chemistry generally has a higher coulombic efficiency and/or a higher power charge acceptance rate (e.g., higher maximum charge current or charge voltage) than the lead-acid battery chemistry. As such, the capture, storage, and/or distribution efficiency of the battery system 12 may be improved.

To facilitate controlling the capturing and storing of electrical energy, the battery system 12 may additionally include a control module 24. More specifically, the control module 24 may control operations of components in the battery system 12, such as relays (e.g., switches) within energy storage component 13, the alternator 15, and/or the electric motor 17. For example, the control module 24 may regulate amount of electrical energy captured/supplied by each battery module 20 or 22 (e.g., to de-rate and re-rate the battery system 12), perform load balancing between the battery modules 20 and 22, determine a state of charge of each battery module 20 or 22, determine temperature of each battery module 20 or 22, control voltage output by the alternator 15 and/or the electric motor 17, and the like.

Accordingly, the control unit 24 may include one or more processor 26 and one or more memory 28. More specifically, the one or more processor 26 may include one or more application specific integrated circuits (ASICs), one or more field programmable gate arrays (FPGAs), one or more general purpose processors, or any combination thereof. Additionally, the one or more memory 28 may include volatile memory, such as random access memory (RAM), and/or non-volatile memory, such as read-only memory (ROM), optical drives, hard disc drives, or solid-state drives. In some embodiments, the control unit 24 may include portions of a vehicle control unit (VCU) and/or a separate battery control module.

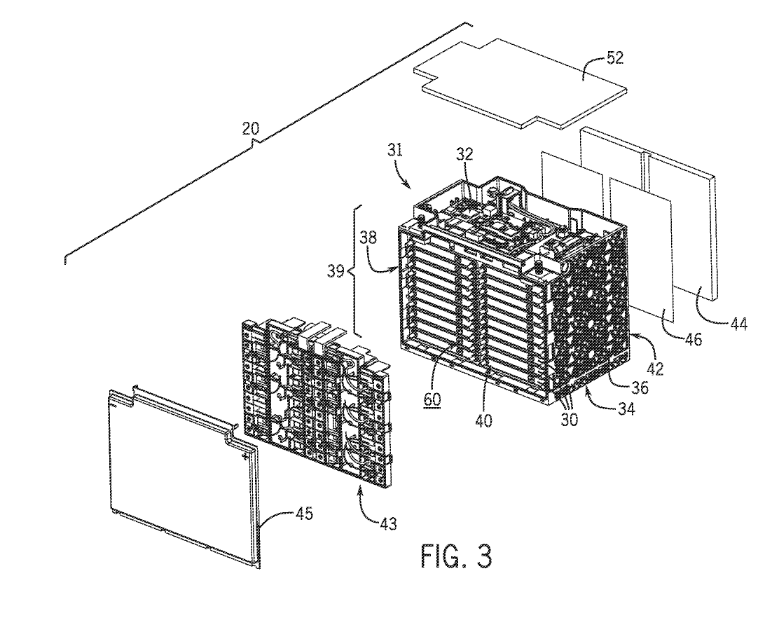

Indeed, a partially exploded perspective view of one exemplary battery module 20 in accordance with the present disclosure is shown in FIG. 3. In the illustrated embodiment, the battery module 20 includes a number of individual electrochemical cells 30 (e.g., Li-ion electrochemical cells) housed in a housing 31 of the battery module 20. The housing 31 includes a top side 32 (e.g., top wall), a bottom side 34 (e.g., bottom wall), and two reinforcing sides 36, 38 (e.g., reinforcing walls), which together form a base structure 39 of the housing 31. The base structure 39 in the illustrated embodiment is open on a front side 40 and includes an open (or partially open) back side 42 that is closed by an evaporator plate 44 in-molded (e.g., overmolded) into the back side 42 of the base structure 39. The open front side 40 may be at least partially closed by an e-carrier 43 of the housing 31, which is configured to establish electrical connections between the electrochemical cells 30 and may also be configured to serve as a cover for the open front side 40 of the base structure 39. An additional cover 45 may fit over the e-carrier 43 to fully enclose (e.g., seal) the housing 31 by fully covering the open front side 40 of the base structure 39. Thermal pads 46 (e.g., adhesive thermal pads or adhesive thermal layers) may be disposed between the evaporator plate 44 and back ends of the electrochemical cells 30. Further, a top cover 52 may fit over the top side 32 of the base structure 39 of the housing 31, where certain components (e.g., thermal management components, control circuitry) of the battery module 20 may be disposed on top of the top side 32, between the top side 32 of the base structure 39 and the top cover 52 of the housing 31.

It should be noted that presently disclosed embodiments may be applicable to any battery module having the same or different configurations and/or orientations described above and in detail below. One of ordinary skill in the art would recognize that the components and examples used to describe battery modules in accordance with the present disclosure should not be construed to limit the present disclosure to those components and examples alone. Rather, the disclosed examples are merely intended to serve as non-limiting examples to facilitate discussion of the present disclosure.

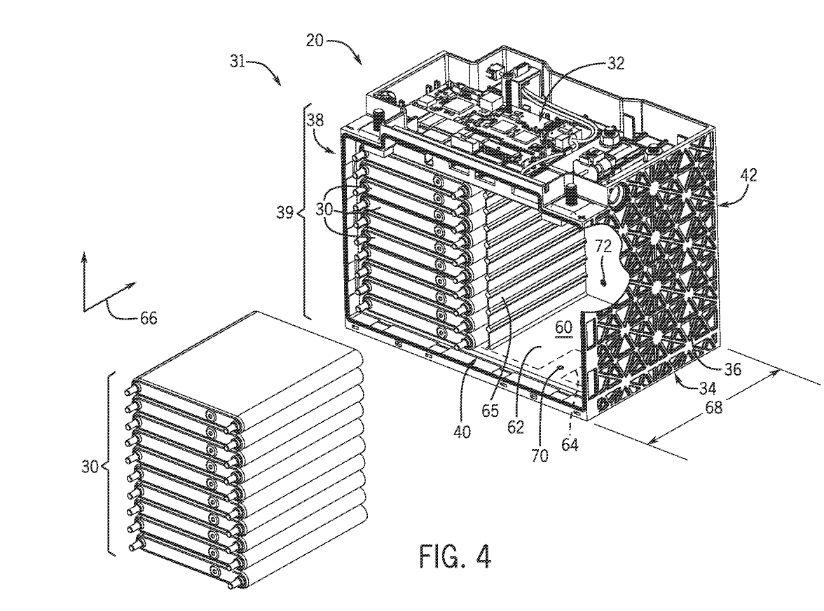

In accordance with the present disclosure, the battery module 20 in FIG. 3 may include water management features configured to retain or drain water from an inside 60 of the base structure 39 of the housing 31 (e.g., where the electrochemical cells 30 are disposed). For example, a partially exploded perspective view of a portion of the battery module 20 in FIG. 3 is shown in FIG. 4. In the illustrated embodiment, a bottom internal surface 62 on the inside 60 of the base structure 39 of the housing 31 includes a recessed portion 64. The bottom internal surface 62 may contact (or be disposed immediately adjacent to) one or more of the electrochemical cells 30, and the recessed portion 64 is recessed into the bottom internal surface 62 away from the electrochemical cells 30. The recessed portion 64 defines an airspace underneath the electrochemical cells 30, where the airspace is configured to retain water or other fluids in the inside 60 of the base structure 39. In other words, the recessed portion 64 on the bottom internal surface 62 is configured to enable fluids to gather in the airspace such that the fluids do not interfere with, for example, the electrochemical cells 30.

In the illustrated embodiment, the battery module 20 includes two columns of electrochemical cells 30 separated by a partition 65. Each column of electrochemical cells 30 may include one recessed portion 64 disposed below the column on the bottom internal surface 62 of the base structure 39 of the housing 31, below the electrochemical cells 30. Alternatively, in some embodiments, only one recessed portion 64 on the bottom internal surface 62 is included for the entire battery module 20. In some embodiments, recessed portions may be included on multiple internal surfaces (e.g., right, left, front, back, bottom) to accommodate variable battery orientations relative to gravity. In the illustrated embodiment, the recessed portion 64 extends from the open front side 40 of the base structure 39 toward the back side 42, in direction 66. It should be noted that the recessed portion(s) 64 may extend an entire length 68 of the bottom internal surface 62 (e.g., from the open front side 40 to the back side 62), or the recessed portion 64 may extend only a portion of the entire length 68 of the bottom internal surface 62. For example, the recessed portion 64 may extend approximately one quarter, approximately one half, or approximately three quarters of the entire length 68 of the bottom internal surface 62. Further, the recessed portion 64 may extend from the open front side 40 toward the back side 42 of the base structure 39, from the back side 42 toward the open front side 40, or otherwise between the open front side 40 and the back side 42.

The size, shape, and/or location of the recessed portion 64 may depend on a number of factors and may vary depending on the embodiment. For example, the size of the recessed portion 64 may depend on an amount of fluid expected to be in the inside 60 of the base structure 39 of the housing 31. Further, the location of the recessed portion 64 may depend on where the fluid is expected to gather. In general, the recessed portion 64 (or portions) is disposed at or proximate to a low or lowest point 70 on the bottom internal surface 62 (e.g., with respect to gravity), such that the fluid is gravity fed into the airspace defined by the recessed portion 64. In some embodiments, the lowest point 70 may be a lowest point of a particular region of the bottom internal surface 62. For example, the bottom internal surface 62 may include multiple regions, each having a lowest point 70. The battery module 20 may be disposed into the vehicle 10 in a particular orientation such that the recessed portion 64 is proximate the lowest point 70 of the bottom internal surface 62 (with respect to gravity), which enables the fluid to be gravity fed into the airspace defined by the recessed portion 64. The recessed portion 64 may include curved or beveled portions that cooperate to function as a funnel. Further, in some embodiments, the recessed portion 64 may be defined, in part, by a substantially flat surface disposed below the bottom internal surface 62, with sloped or angled surfaces extending between the bottom internal surface 62 and the substantially flat surface of the recessed portion 64. The sloped or angled surfaces may enable the fluid on the inside 60 of the housing 31 to travel toward the substantially flat surface of the recessed portion 64 and into the airspace defined by the recessed portion 64.

It should also be noted that, in some embodiments, the recessed portion 64, (and the airspace thereof) may retain fluid within the inside 60 of the base structure 39 of the housing 31 only temporarily. For example, during operation of the battery module 20, the inside 60 of the base structure 39 may become hot and may temporarily vaporize fluid gathered in the airspace of the recessed portion 64, such that the vaporized fluid may be present anywhere in the inside 60 of the base structure 39. When the battery module 20 is not operating, the fluid may condense and again gather in the airspace defined by the recessed portion 64 of the bottom internal surface 62. During the lifecycle of the battery module 20, more and more fluid may ingress into the inside 60 of the base structure 39 of the housing 31. Eventually, a volume of the fluid in the inside 60 of the base structure 39 may exceed a volume of the airspace defined by the recessed portion 64 on the bottom internal surface 62 of the base structure 39. Thus, during maintenance intervals, the snap on e-carrier 43 (See FIG. 3), or some other portion of the housing 31, may be temporarily removed for accessing the inside 60 of the housing 31 (or the base structure 39 thereof), such that the fluid may be removed from the airspace defined by the recessed portion 64. Indeed, in certain embodiments, a humidity sensor 72 may be disposed on the inside 60 of the base structure 39 and may alert an operator if humidity exceeds a pre-defined tolerance level. Additionally or alternatively, some other type of sensor (e.g., a water pressure sensor) may be used for determining if and when fluid levels exceed a tolerated amount on the inside 60 of the base structure 39. In some embodiments, one or more absorbent features (e.g., sponges) may be disposed in the recessed portion 64 to manage liquid distribution.

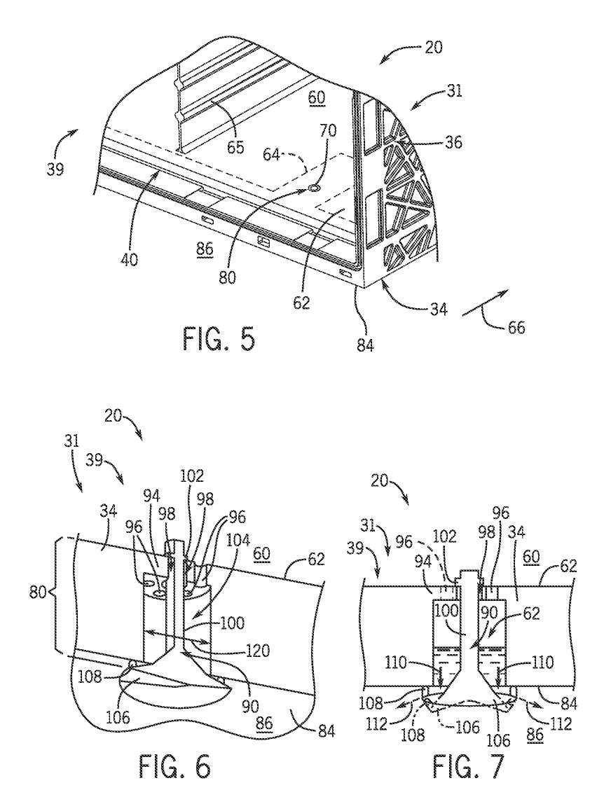

Further, in some embodiments, the battery module 20 may include water management features in addition to, or as an alternate for, the recessed portion 64 (and airspace thereof) described above. For example, a perspective view of a portion of the housing 31 of the battery module 20 of FIG. 3 is shown in FIG. 5. In the illustrated embodiment, the base structure 39 of the housing 31 includes a pinhole or opening 80 extending from the bottom internal surface 62 (e.g., the bottom internal surface 62) of the bottom side 34 (e.g., bottom wall) of the base structure 39 to a bottom external surface 84 of the bottom side 34 (e.g., bottom wall), where the opening 80 is configured to drain fluid from the inside 60 of the base structure 39 of the housing 31 to an external area 86 outside of the housing 31.

In the illustrated embodiment, the opening 80 is disposed at or proximate to the low or lowest point 70 of the bottom internal surface 62 (or one region thereof, as previously described). For example, in some embodiments, the bottom internal surface 62 may be sloped slightly toward the opening 80. Thus, fluid on the inside 60 of the housing 31 is gravity fed toward the opening 80 and gravity fed through the opening 80. Further, depending on the embodiment, the housing 31 may include both the opening 80 and the recessed portion 64 (e.g., with the opening 80 disposed in the recessed portion 64), such that the fluid is gravity fed into the airspace defined by the recessed portion 64 and gravity fed through the opening 80. In other embodiments, the base structure 39 may only include the opening 80, as described above.

Further, in some embodiments, the housing 31 (e.g., the base structure 39 of the housing 31) may include some type of seal, sealing mechanism, or sealing assembly (e.g., self-sealing port) for selectively sealing the opening 80. For example, a bottom perspective view of a portion of the housing 31 of the battery module 20 of FIG. 3 is shown in FIG. 6, where the base structure 39 includes the opening 80 and a plunger device 90 (e.g., a type of self-sealing port) for selectively sealing the opening 80. In the illustrated embodiment, the opening 80 extends through the bottom side 34 of the base structure 39 from the bottom internal surface 62 to the bottom external surface 84. Specifically, the opening 80 includes an extension 94 of the bottom internal surface 62 that is perforated with multiple holes 96 that extend into the cavity 104. One of the holes 96 is a central opening 98 which is configured to receive a stem 100 (e.g., a body) of the plunger device 90. A protruding head 102 of the plunger device 90 extends from a top of the stem 100 and is configured to contact the bottom internal surface 62 on the inside 60 of the base structure 39, such that the plunger device 90 is retained in the opening 80.

Generally, the multiple holes 96 disposed annularly through the extension 94 and about the central opening 98 (and, thus, around the stem 100 and the protruding head 102 of the plunger device 90) fluidly couple the inside 60 of the housing 31 (e.g., through the multiple holes 96) with a cavity 104 of the opening 80. The cavity 104 is configured to receive fluid from the inside 60 of the base structure 39 of the housing 31 and to retain the fluid as the fluid presses against a flexible plunger head 106 of the plunger device 90. The flexible plunger head 106 includes an annular ridge 108 configured to contact the bottom external surface 84 of the bottom side 34 of the base structure 39 of the housing 31. The annular ridge 108 seals the cavity 104 from the external area 86 outside of the housing 31 (or base structure 39 thereof). However, as more fluid gathers within the cavity 104, a fluid pressure against the flexible plunger head 106 increases. Once the fluid pressure exceeds a tolerance of the flexible plunger head 106, the flexible plunger head 106 will flex open, causing the annular ridge 108 to be separated from the bottom external surface 84. While the flexible plunger head 106 is flexed open in an open position (e.g., with the annular ridge 108 separated from the bottom external surface 84), the fluid drains from the cavity 104. As the fluid drains from the cavity 104, the fluid pressure against the flexible plunger head 106 decreases. Once the tolerance of the flexible plunger head 106 exceeds the fluid pressure of the fluid in the cavity 104 against the flexible plunger head 106, the flexible plunger head 106 flexes back into a closed position, causing the annular ridge 108 to contact, and seal against, the bottom external surface 84 of the bottom side 34 (e.g., bottom wall) of the base structure 39.

A cross-sectional side view of the opening 80 having the plunger device 90 of FIG. 6 is shown in FIG. 7. As previously described, fluid gathers in the cavity 104 and exerts pressure against the flexible plunger head 106 of the plunger device 90, as indicated by arrows 110. Once the fluid pressure exceeds a pressure tolerance of the flexible plunger head 106, the flexible plunger head 106 flexes open into the open position, as shown in dashed lines in the illustrated embodiment. With the flexible plunger head 106 in the open position, the annular ridge 108 separates from the bottom external surface 84, as also shown in dashed lines. With the annular ridge 108 separated from the bottom external surface 84, the fluid is enabled to drain from the opening 80 (e.g., from the cavity 104 of the opening 80), as indicated by arrows 112. Once the pressure tolerance of the flexible plunger head 106 exceeds the pressure of the fluid against the flexible plunger head 106 (e.g., arrows 110), the flexible plunger head 106 flexes closed into the closed position, such that the annular ridge 108 contacts, and seals against, the bottom external surface 84.

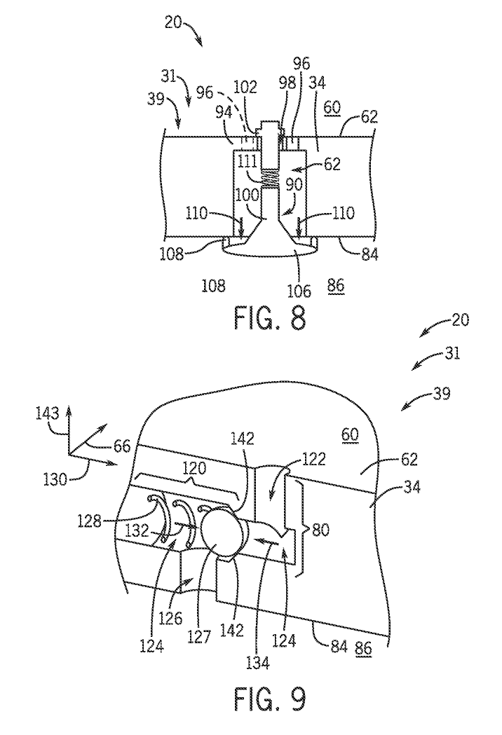

In some embodiments, the plunger device 90 may include some other flexible member configured to be calibrated to respond to a fluid pressure (e.g., to drain the fluid) within the cavity 104 of the opening 80. For example, in FIG. 8, the stem 100 includes a spring 111 configured to flex in response to a fluid pressure against the plunger head 106 of the plunger device 90. Depending on the embodiment, the plunger head 106 may or may not be flexible, and may or may not flex in conjunction with the spring 111 to enable drainage of fluid from the inside 60 of the base structure 39 to the outside 86 of the base structure 39.

It should be noted that the plunger device 90 and the corresponding opening 80 may be configured in a manner other than what is shown in FIGS. 6, 7, and 8. For example, the extension 94 having the multiple holes 96 and the central opening 98 may be otherwise configured. In certain embodiments, the extension 94 may have 1, 2, 3, 4, 5, 6, 7, 8, or more holes 96 for fluidly coupling the inside 60 of the housing 31 to the cavity 104. Further, the holes 96 may or may not be disposed annularly and/or evenly spaced around the central opening 98, as shown. Indeed, the opening 80 may not even include the extension 94. For example, in some embodiments, the inside 60 of the housing 31 may be directly fluidly coupled to the cavity 104, where the protruding head 102 of the plunger device 90 spans an entire width 121 of the cavity and contacts the bottom internal surface 62 on the inside 60 of the housing 31, such that the plunger device 90 is retained in the opening 80. The fluid, then, may enter directly into the cavity 104 from the inside 60 of the housing 31, without first passing through openings (e.g., holes 96). The illustrated embodiments (e.g., having the extension 94 and the holes 96) are meant as a non-limiting example of one type of self-sealing port utilizing a plunger-like seal. However, other types of seals and other embodiments of the illustrated plunger device 90 may be utilized similarly for selectively sealing the opening 80 that extend through the bottom side 34 of the base structure 39 of the housing 31.

For example, a cross-sectional perspective view of an embodiment of the base structure 39 (e.g., of the housing 31) of the battery module 20 of FIG. 3 is shown in FIG. 9, where the opening 80 in the bottom side 34 of the base structure 39 includes a pressure relief seal assembly 120. In the illustrated embodiment, the opening 80 includes a first segment 122 (e.g., first vertical segment), an intervening, intermediate, or cross-wise segment 124 coupled to the first segment 122, and a second segment 126 (e.g., second vertical segment) coupled to the cross-wise segment 124. The pressure relief seal assembly 120 is disposed in the cross-wise segment 124 of the opening 80.

The pressure relief seal assembly 120 includes a pressure ball 127 disposed in the cross-wise segment 124 of the opening 80. The pressure ball 127 is configured to selectively seal the first segment 122 from the second segment 126, thus selectively sealing the inside 60 of the housing 31 from the external area 86 outside of the housing 31. For example, a spring 128 is disposed in the cross-wise segment 124 and exerts a biasing force against the pressure ball 127 in direction 130, as indicated by arrow 132. However, as fluid gathers on the inside 60 of the base structure 39 of the housing 31, the fluid drains into the first segment 122 and the right side of the cross-wise segment 124 in the illustrated embodiment. The fluid exerts a fluid pressure against the pressure ball 127 opposite to direction 130, as indicated by arrow 134. If the fluid pressure (arrow 134) exceeds the biasing force (arrow 132) of the spring 128, the pressure ball 127 will move opposite to direction 130. As the pressure ball 127 moves over and beyond at least a portion of the second segment 126 (e.g., opposite to direction 130), the fluid is enabled to drain through the first segment 124, through the cross-wise segment 124, and through the second segment 126 to the external area 86 outside of the base structure 39 of the housing 31. As the fluid drains from the inside 60 of base structure 39 to the external area 86 outside of the housing 31, the fluid pressure against the pressure ball 127 decreases, and the biasing force of the spring 128 may eventually overcome or exceed the fluid pressure. Thus, the pressure ball 127 moves in direction 130 until the pressure ball 127 selectively seals the first segment 122 from the second segment 126, as previously described.

It should be noted that the pressure ball 127, in the illustrated embodiment, may be some other shape disposed within the cross-wise segment 124. For example, in the illustrated embodiment, the pressure ball 127 is shown as a sphere. However, in another embodiment, the pressure ball 127 may be any shape capable of sealing the first segment 122 from the second segment 126 within the cross-wise segment 124. For example, the pressure ball 127 may be a pressure cylinder with circular faces facing in direction 130 and opposite to direction 130, or any other shape capable of sealing within the cross-wise segment 124. Further, in the illustrated embodiment, to block the biasing force of the spring 128 from causing the pressure ball 127 to move too far in direction 130 (e.g., up to and beyond at least a portion of the first segment 122), a lip or seat 142 is disposed in the cross-wise segment 124. The seat 142 restricts a cross-sectional area of the cross-wise segment 124 such that the pressure ball 127 contacts the seat 142 and is blocked from moving in direction 130 up to or beyond the first segment 122. This contact also provides a seal.

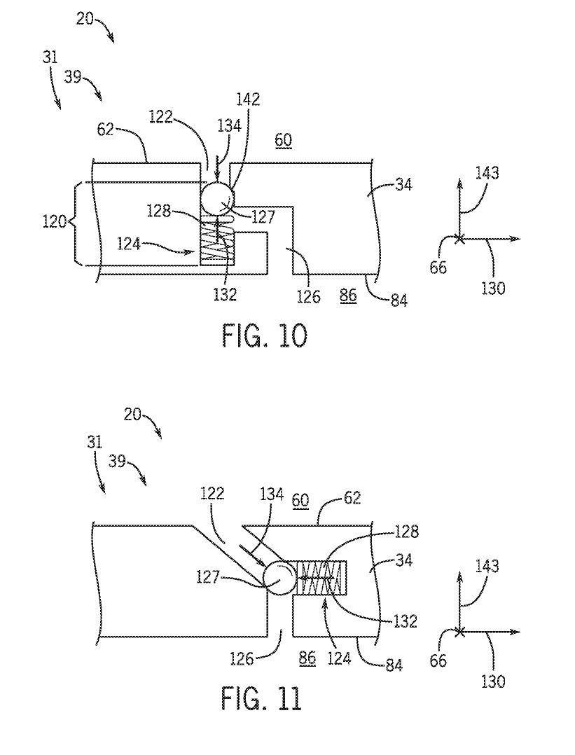

It should also be noted that the first segment 122 (e.g., first vertical segment), the cross-wise segment 124 (e.g., intervening segment, transverse segment, horizontal segment), and the second segment 126 (e.g., second vertical segment) may be otherwise oriented. For example, the first segment 122 may be angled with respect to direction 143, the cross-wise segment 124 may be angled with respect to direction 130, and the second segment 126 may be angled with respect to direction 143. In general, the segments 122, 124, 126 are configured to utilize gravity and fluid pressure to drain the fluid from the inside 60 of the base structure 39 of the housing 31. Any angles for the segments 122, 124, 126 capable of gravity feeding the fluid through the segments 122, 124, 126 by utilizing fluid pressure against the pressure seat 127 is in accordance with the present disclosure. For example, embodiments of the present disclosure having a pressure relief seal assembly 120 with segments oriented in various directions and/or configurations are shown in FIGS. 10 and 11.

One or more of the disclosed embodiments, alone or in combination, may provide one or more technical effects useful in the manufacture of battery modules, and portions of battery modules. In general, the disclosed battery modules (and housings/base structures thereof) include water management features generally disposed at a low or lowest point in a bottom internal surface of a bottom end of the housing. The water management features are configured to receive gravity fed fluid from inside of the housing, such that the water management features may retain and/or drain the fluid safely away from electrochemical cells and other components of the battery module. The water management features generally provide safe retention and draining of fluid from the inside of the housing of the battery module such that the fluid does not interfere with, for example, electrical components of the battery module and electrochemical cells thereof. The water management features are configured to be substantially contained within a bottom side of the base structure of the housing of the battery module, such that the housing (and water management features thereof) is compact and the water management features do not excessively contribute to an increased volume (and thus, a decreased energy density) of the battery module. The technical effects and technical problems in the specification are exemplary and are not limiting. It should be noted that the embodiments described in the specification may have other technical effects and can solve other technical problems.

While only certain features and embodiments have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the disclosed subject matter. The order or sequence of any process or method steps may be varied or re-sequenced according to alternative embodiments. Furthermore, in an effort to provide a concise description of the exemplary embodiments, all features of an actual implementation may not have been described. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A battery module comprising:
a housing having an interior space partially defined by a bottom surface on a bottom side of the housing, the housing having an opening that extends from the bottom surface to a surface on the exterior of the housing, wherein the opening has a pressure relief valve disposed therein and which opens under pressure to release accumulated water in the interior space of the battery module.

2. The battery module of claim 1 wherein the opening is located in a low point of the bottom surface.

3. The battery module of claim 2 wherein the low point is a recessed portion of the bottom surface.

4. The battery module of claim 1 wherein the battery module further contains electrochemical cells having a lithium-ion chemistry in the interior space.

5. The battery module of claim 3 wherein the battery module further contains an electrochemical cell having a lithium-ion chemistry and the recessed portion forms an airspace between the bottom surface and the electrochemical cell.

6. The battery module of claim 3 wherein the housing further comprises a front side and a back side opposing the front side, the recessed portion extending along the bottom surface between 25 and 75 percent of a total length of the bottom surface.

7. The battery module of claim 1 wherein the pressure relief valve includes a plunger having a stem that fits within the opening.

8. The battery module of claim 7 wherein the plunger further has an enlarged portion on a first end of the stem closest the surface on the exterior of the housing and a collar at an opposing second end of the stem closest the bottom side, the collar abutting against the bottom side when the pressure relief valve is open.

9. The battery module of claim 8 wherein the enlarged portion of the plunger includes a frusto-conical portion that dovetails in a countersunk portion of the opening.

10. The battery module of claim 8 wherein the enlarged portion includes a flexible portion that seals against the opening in a normally closed position until a pressure of a preselected threshold pressure forces the plunger to an open position.

11. The battery module of claim 8 wherein the stem has a spring mounted intermediate the first end and the second end of the stem, and the spring has a stiffness such that the enlarged portion of the plunger seals against the surface on the exterior of the housing in a normally closed position until a pressure of a preselected threshold pressure forces the enlarged portion of the plunger away from the surface of the exterior of the housing to an open position.

12. The battery module of claim 1 wherein the pressure relief valve is of a type that includes a ball and a spring.

13. The battery module of claim 12 wherein there is a channel connected to the opening and the channel has the spring disposed in such channel, and further wherein the ball is located in the opening to block the opening when the pressure relief is normally closed, and the ball depresses against the spring in the channel when a pressure of a preselected threshold pressure to no longer block the opening.

14. A battery module, comprising:
a housing configured to house a plurality of electrochemical cells, wherein the housing comprises:
a bottom internal surface on a bottom side of the housing; and
an opening extending through the bottom side from the bottom internal surface to a bottom external surface and disposed at a low point on the bottom internal surface, such that fluid is gravity fed from the bottom internal surface toward the opening, wherein the opening is configured to selectively drain the fluid from an inside of the housing to an outside of the housing and the opening comprises a self-sealing port having a plunger seal or a pressure relief seal.

15. The battery module of claim 14, comprising the plunger seal, wherein the plunger seal comprises a plunger device extending through the opening from the bottom internal surface on the inside of the housing to the bottom external surface on the outside of the housing, wherein the plunger device comprises:
a top head configured to contact the bottom internal surface on the inside of the housing;
a body extending downwardly from the top head through a cavity of the opening; and
a flexible sealing head coupled to the body and configured to seal against the bottom external surface on the outside of the housing, wherein the flexible sealing head is configured to flex to open the plunger seal when a fluid pressure against the flexible sealing head from within the cavity exceeds a fluid pressure tolerance of the flexible sealing head.

16. The battery module of claim 15, wherein the housing comprises an extension extending from the bottom internal surface around a central opening of the opening proximate the bottom internal surface of the housing, and the extension comprises one or more holes disposed about the central opening and configured to enable fluid communication between the inside of the housing and the cavity of the opening, such that the fluid enters the cavity from the inside of the housing through the one or more holes and exerts the fluid pressure against the flexible sealing head.

17. The battery module of claim 14, comprising the pressure relief seal, wherein the opening comprises a first segment extending downwardly from the bottom internal surface, an intermediate segment extending cross-wise from the first segment, and a second segment extending downwardly from the intermediate segment to the bottom external surface of the bottom side of the housing, wherein the pressure relief seal comprises:
a pressure ball configured to seal the first segment from the second segment, wherein the pressure ball is disposed within the intermediate segment and comprises a first side in fluid communication with the first segment; and
an actuating mechanism extending from a second side of the pressure ball opposite the first side and through the intermediate segment, wherein a fluid pressure against the first side of the pressure ball is configured to actuate the pressure ball toward and beyond at least a portion of the second segment via compression of the actuating mechanism, such that the fluid is drained through the first segment, through the intermediate segment, and through the second segment.

18. The battery module of claim 17, wherein the actuating mechanism comprises a spring.

19. The battery module of claim 18, comprising a recessed portion disposed in the bottom internal surface and defining an airspace configured to receive the fluid, wherein the opening is disposed within the recessed portion and is configured to drain the fluid from the airspace through the bottom side of the housing.

20. The battery module of claim 18, comprising the plurality of electrochemical cells, wherein the plurality of electrochemical cells comprises a plurality of Lithium-ion electrochemical cells.

21. A battery module, comprising:
a housing configured to receive one or more electrochemical cells, wherein the housing comprises:
a bottom internal surface; and
a recessed portion disposed in the bottom internal surface and proximate to a low point on the bottom internal surface, wherein the recessed portion defines an airspace configured to retain fluid within the housing away from the one or more electrochemical cells.

22. The battery module of claim 21, wherein the housing comprises a front side and a back side and the bottom internal surface extends between the front side and the back side.

23. The battery module of claim 22, wherein the recessed portion extends along the bottom internal surface from the front side to the back side.

24. The battery module of claim 22, wherein the recessed portion extends along the bottom internal surface between approximately 25 and 75 percent of a total length of the bottom internal surface between the front side and the back side.

25. The battery module of claim 21, wherein an opening is disposed in the recessed portion of the bottom internal surface and the opening is configured to drain the fluid from the airspace to an outside of the housing.

26. The battery module of claim 21, wherein the recessed portion comprises a substantially flat surface disposed below the bottom internal surface and the airspace is disposed between the bottom internal surface and the substantially flat surface.

27. The battery module of claim 26, wherein a sloped surface or edge extends from the bottom internal surface to the substantially flat surface.

28. A housing configured to house a plurality of electrochemical cells, wherein the housing comprises:
a bottom side having a bottom internal surface; and
an opening extending through the bottom side and disposed at a low point on the bottom internal surface such that fluid is gravity fed from the bottom internal surface toward the opening, wherein the opening is configured to drain the fluid through the bottom side of the housing.

29. The housing of claim 28, wherein the opening of the housing comprises a self-sealing port having a plunger seal or a pressure relief seal.

30. The housing of claim 28, comprising a plunger seal, wherein the plunger seal comprises a plunger device extending through the opening from the bottom internal surface to a bottom external surface of the bottom side, wherein the plunger device comprises:
a top head configured to contact the bottom internal surface on an inside of the housing and to retain the plunger device in the opening;
a body extending from the top head downwardly through a cavity of the opening; and
a flexible sealing head disposed on an outside of the housing and configured to seal against the bottom external surface, wherein the flexible sealing head is configured to flex to open the plunger seal when a fluid pressure against the flexible sealing head from within the cavity exceeds a fluid pressure tolerance;

31. The housing of claim 30, wherein the housing comprises an extension extending from the bottom internal surface around a central opening of the opening proximate the bottom internal surface of the housing, wherein the plunger device extends through the central opening, and wherein the extension comprises one or more holes disposed around the central opening and configured to enable fluid communication between the inside of the housing and the cavity of the opening, such that the fluid enters the cavity from the inside of the housing through the one or more holes and exerts the fluid pressure against the flexible sealing head.

32. The housing of claim 28, comprising a pressure relief seal disposed in the opening, wherein the opening comprises a first segment extending downwardly from the bottom internal surface, a second segment extending cross-wise from the first segment, and a third segment extending downwardly from the second segment to a bottom external surface on an outside of the housing opposite the bottom internal surface on an inside of the housing, and wherein the pressure relief seal comprises:
a pressure ball configured to seal the first segment from the third segment, wherein the pressure ball is disposed within the second segment and comprises a first side in fluid communication with the first vertical segment; and
an actuating mechanism extending from a second side of the pressure ball opposite the first side and through the second segment, wherein a fluid pressure against the first side of the pressure ball is configured to actuate the pressure ball toward and beyond at least a portion of the third segment via compression of the actuating mechanism, such that the fluid is drained through the first segment, through the second segment, and through the third segment.

33. The housing of claim 32, wherein the actuating mechanism comprises a spring.

34. The housing of claim 28, comprising a recessed portion disposed in the bottom internal surface and defining an airspace configured to receive the fluid, wherein the opening is disposed within the recessed portion and is configured to drain the fluid from the airspace.
